(19) United States
(12) Patent Application Publication
(10) Pub. No.: US 2013/0192314 A1
(43) Pub. Date: Aug. 1, 2013

(54) PICK-RESISTANT HANDCUFFS

(71) Applicant: Yang-Fu CHENG, Taipei (TW)

(72) Inventor: Yang-Fu CHENG, Taipei (TW)

(73) Assignee: Acellent Co., Ltd., New Taipei City (TW)

(21) Appl. No.: 13/430,781

(22) Filed: Mar. 27, 2012

(30) Foreign Application Priority Data
Jan. 31, 2012 (TW) 101201743

(51) Int. Cl. E05B 75/00

(52) U.S. Cl. 70/16

(57) ABSTRACT

The present invention provides a pick-resistant handcuff, which includes a fixed arc-shaped hook having an accommodation chamber, a movable arc-shaped hook having one end pivotally connected to the fixed arc-shaped hook and a plurality of projecting teeth provided at the other end thereof which can be rotated into the accommodation chamber, an elastic member having one end fixed in the accommodation chamber and another end split into two pressing parts, two locking members pivotally connected in the accommodation chamber and each pressed by the corresponding pressing part and provided with a plurality of lock projecting teeth for engaging with the projecting teeth, and a spacer located between the two locking members and having a through hole corresponding in configuration to a key tooth groove of a key. Thus, the movable arc-shaped hook can only be released from engagement with the locking members by the key, but not a pointed object.

### FIELD OF THE INVENTION

The present invention relates to a handcuff, more particularly to a pick-resistant handcuff, which includes two locking members pivotally connected in an accommodation chamber of a fixed arc-shaped hook and pressed by two pressing part of an elastic member respectively so as to allow the two locking members to be engaged with a movable arc-shaped hook pivotally connected to the fixed arc-shaped hook, and a spacer located between the two locking members. When a person restrained by the handcuff tries to unlock the handcuff by using a pointed object, the pointed object can only push one of the locking members because the other locking member is blocked by the spacer. Therefore, unless using a key having a key tooth groove corresponding to the spacer, the locking effect of the handcuff will be effectively ensured.

### BACKGROUND OF THE INVENTION

Handcuffs, typically made of metal, are devices for restraining a person's wrists and are usually used by the police or military force to limit free movement of a suspect or criminal under arrest or detention, thereby preventing the handcuffed person from escape. Referring to FIG. 1, a common pair of handcuffs 1 includes two handcuff main bodies 10 and a chain 11 connecting the handcuff main bodies 10. Each handcuff main body 10 is composed essentially of a fixed arc-shaped hook 100 and a movable arc-shaped hook 101. The movable arc-shaped hook 101 has one end pivotally connected to the fixed arc-shaped hook 100 and can rotate about the pivotally connecting portion. The fixed arc-shaped hook 100 is provided therein with a locking mechanism and is formed with a key hole 100a corresponding in position to the locking mechanism in the fixed arc-shaped hook 100. The movable arc-shaped hook 101, on the other hand, is provided with a plurality of projecting teeth 101a. The locking mechanism inside the fixed arc-shaped hook 100 can engage with the projecting teeth 101a of the movable arc-shaped hook 101 such that the movable arc-shaped hook 101 cannot be disengaged from the fixed arc-shaped hook 100 on its own.

As shown in FIG. 2, the fixed arc-shaped hook 100 is provided therein with an accommodation chamber 100b for accommodating the aforesaid locking mechanism. The locking mechanism mainly includes a locking member 12 and an elastic member 13. The locking member 12 is pivotally provided in the accommodation chamber 100b. The bottom side of the locking member 12 is protrudingly provided with a plurality of lock projecting teeth 120. The elastic member 13 is disposed in the accommodation chamber 100b and presses the locking member 12 elastically so as for the locking member 12 to pivot downward about the pivotally connecting portion thereof. This structural feature allows the lock projecting teeth 120 on the locking member 12 to engage with the projecting teeth 101a of the movable arc-shaped hook 101 and thereby limit the movable arc-shaped hook 101 in position. Once so engaged, the movable arc-shaped hook 101 cannot be disengaged without further intervention. The structural features described above are such that the handcuff main body 10 can be closed around a suspect's wrist to effectively limit the suspect's movement as long as the movable arc-shaped hook 101 and the fixed arc-shaped hook 100 are connected to each other at both ends and the lock projecting teeth 120 are engaged with the projecting teeth 101a of the movable arc-shaped hook 101.

Moreover, referring to FIG. 2 in conjunction with FIG. 1, the right end of the locking member 12 is protrudingly provided with a side projecting part 121 corresponding in position to the key hole 100a. When a user (e.g., a policeman or military person) inserts a key 2 into the key hole 100a and turns the key 2, the key tooth 20 on the key 2 pushes the side projecting part 121 upward such that the locking member 12, which is pivotally provided in the accommodation chamber 100b, is driven to rotate by the key tooth 20. Consequently, the locking member 12 is moved upward against the resilient force of the elastic member 13 and compresses the elastic member 13, causing separation between the lock projecting teeth 120 of the locking member 12 and the projecting teeth 101a of the movable arc-shaped hook 101. The user can now rotate the movable arc-shaped hook 101 to open the handcuff main body 10. As soon as the key 2 is pulled out, the elastic member 13 pushes the locking member 12 downward as before key insertion, and the movable arc-shaped hook 101 can be rotated into engagement with the fixed arc-shaped hook 100 again.

While the foregoing conventional handcuffs have such advantages as structural simplicity and easy operation, there is still room for improvement. Based on years of research and practical experience, the inventor of the present application has found that a handcuffed suspect may attempt to unlock the handcuffs with a pointed object such as a metal hairpin or nail. Referring again to FIGS. 1 and 2, a handcuffed suspect may bend a pointed object such as a metal hairpin or nail (not shown), insert the pointed object into the key hole 100a, and push the side projecting part 121 of the locking member 12 by turning the pointed object. The lock projecting teeth 120 of the locking member 12 may be separated from the projecting teeth 101a of the movable arc-shaped hook 101 as a result and lose the locking effect, thus allowing the suspect to open the handcuff main body 10 and escape. In other words, the conventional handcuffs may fail to limit a suspect's movement, which is highly undesirable.

One proposed solution to the aforesaid problem is to increase the number of the locking member, to two for example, with a view to increasing the difficulty of unlocking the handcuffs. Nevertheless, a handcuffed suspect may still manage to push both locking members simultaneously with a thicker or broader pointed object inserted in the key hole of the handcuff main body. Research and observation by the inventor of the present application show that there were indeed cases where a handcuffed suspect succeeded in pushing two locking members such that the movable arc-shaped hook was released from engagement with the two locking members. Therefore, even the improved handcuffs are likely to be unlocked by the handcuffed person himself or herself and cannot effectively ensure the intended locking effect.

Accordingly, the issue to be addressed by the present invention is to overcome the various drawbacks of the existing handcuffs so that a handcuffed person is prevented from unlocking the handcuffs with a pointed object, thereby effectively ensuring the locking effect of the handcuffs.

### BRIEF SUMMARY OF THE INVENTION

In view of the aforesaid drawbacks of the conventional handcuffs, the inventor of the present invention conducted extensive research and experiment and finally succeeded in developing pick-resistant handcuffs as disclosed herein. Once the disclosed handcuffs are applied to a person (e.g., a suspect or criminal), the locking mechanism in each handcuff main body of the handcuffs cannot be unlocked by the handcuffed person with a pointed object and thus ensures the intended locking effect.

It is an object of the present invention to provide pick-resistant handcuffs including at least two handcuff main bodies, wherein each handcuff main body includes a fixed arc-shaped hook, a movable arc-shaped hook, an elastic member, two locking members, and a spacer. The fixed arc-shaped hook has an opening on the inner side. An accommodation chamber extends inward from the opening and is extended with a key recessed part. The movable arc-shaped hook has one end pivotally connected to the fixed arc-shaped hook, and a plurality of projecting teeth are provided adjacent to the other end of, and along the outer periphery of, the movable arc-shaped hook. The movable arc-shaped hook can be rotated toward the opening so that the projecting teeth correspond in position to the opening. The elastic member has a bent configuration. A portion of the elastic member that is adjacent to a first end thereof is fixed in the accommodation chamber. A portion of the elastic member that is adjacent to a second end thereof is split into two pressing parts. The locking members are pivotally connected in the accommodation chamber. Each locking member has one side that is adjacent to the opening and provided with a plurality of lock projecting teeth. The pressing parts of the elastic member press the locking members respectively and elastically so as for the lock projecting teeth of each locking member to engage with the projecting teeth of the movable arc-shaped hook. The spacer is fixed in the accommodation chamber and located between the two locking members. A through hole is formed in the spacer, adjacent to one end thereof, situated in the key recessed part, and extended with a tooth hole corresponding in configuration to a key tooth groove of a key. Thus, when the key, which has two key teeth, is inserted into the key recessed part through the through hole such that the two key teeth correspond in position to the locking members respectively, the key can be turned, driving the two key teeth to push the locking members at the same time, thus causing separation between the locking members and the movable arc-shaped hook and thereby opening the handcuff main body. Even if a person restrained by the handcuffs inserts a pointed object into the key recessed part and tries to unlock the handcuff main body by pushing the locking members with the pointed object, the pointed object can only push one of the locking members because the other locking member is blocked by the spacer between the two locking members. In other words, the pointed object cannot release the movable arc-shaped hook from engagement with the locking members completely, and therefore the locking effect of the handcuffs is effectively ensured.

It is another object of the present invention to provide the foregoing pick-resistant handcuffs, wherein the accommodation chamber is protrudingly provided therein with a pivot, and each locking member is penetrated by a pivot hole. The pivot holes are mounted around the pivot such that the locking members are pivotally connected in the accommodation chamber.

Yet another object of the present invention is to provide the foregoing pick-resistant handcuffs, wherein each handcuff main body further includes a stop block. The stop block is received in the accommodation chamber at a position away from the opening. In addition, the stop block is concavely provided with an alignment recessed part at a position facing the opening, and the portion of the elastic member that is adjacent to the first end thereof is bent into an alignment bent part. The alignment bent part is located in and abuts against the alignment recessed part to secure the elastic member in position.

Still another object of the present invention is to provide pick-resistant handcuffs including at least two handcuff main bodies, wherein each handcuff main body includes a fixed arc-shaped hook, a movable arc-shaped hook, two elastic members, two locking members, and a spacer. The fixed arc-shaped hook has an opening on the inner side. An accommodation chamber extends inward from the opening and is extended with a key recessed part. The movable arc-shaped hook has one end pivotally connected to the fixed arc-shaped hook, and a plurality of projecting teeth are provided adjacent to the other end of, and along the outer periphery of, the movable arc-shaped hook. The movable arc-shaped hook can be rotated toward the opening so that the projecting teeth correspond in position to the opening. Each elastic member has a bent configuration. In addition, a portion of each elastic member that is adjacent to a first end thereof is fixed in the accommodation chamber, and a portion of each elastic member that is adjacent to a second end thereof is formed as a pressing part. The locking members are pivotally connected in the accommodation chamber. Each locking member has one side that is adjacent to the opening and provided with a plurality of lock projecting teeth. The pressing part of each elastic member presses a corresponding one of the locking members elastically so as for the lock projecting teeth of the locking members to engage with the projecting teeth of the movable arc-shaped hook. The spacer is fixed in the accommodation chamber and located between the two locking members. A through hole is formed in the spacer, adjacent to one end thereof, situated in the key recessed part, and extended with a tooth hole corresponding in configuration to a key tooth groove of a key. Thus, even if a person restrained by the handcuffs of the present invention inserts a conventional handcuff key, which has only one key tooth, into the key recessed part and tries to unlock the handcuffs, the two locking members will not be pushed at the same time. As a result, the movable arc-shaped hook will not be opened, and the handcuffed person is effectively prevented from escaping the restraint of the handcuffs.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a perspective view of a pair of conventional handcuffs;

FIG. 2 schematically shows the internal structure of the conventional handcuffs depicted in FIG. 1;

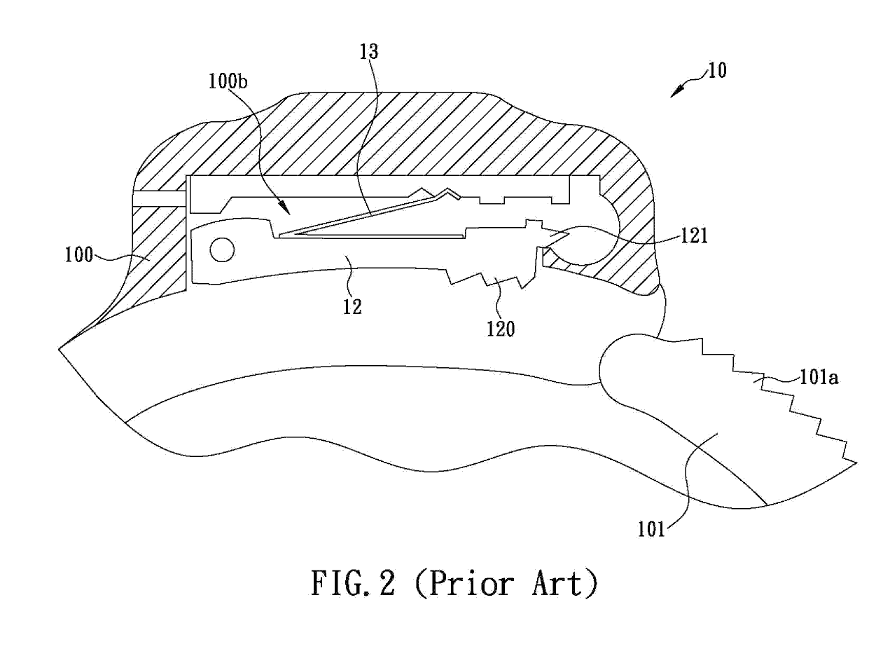

FIG. 3 is an exploded perspective view of a preferred embodiment of the present invention;

FIG. 4 is a partial enlarged view of the preferred embodiment depicted in FIG. 3;

FIG. 5 is a perspective view of certain components of the present invention and a key;

FIG. 6 is a perspective view of certain components of the present invention and a pointed object; and

FIG. 7 is a partial exploded perspective view of another preferred embodiment of the present invention.

### DETAILED DESCRIPTION OF THE INVENTION

The inventor of the present invention has long been engaged in the research, development, and manufacture of handcuffs. In the process, the inventor has found that a person (e.g., a suspect or criminal) restrained by a conventional pair of handcuffs is likely to unlock the locking mechanism in the handcuff main bodies by means of a pointed object, causing disengagement of the movable arc-shaped hooks from their respective fixed arc-shaped hooks, thus allowing the handcuffed person to open the handcuffs on his or her own. Although attempts have been made to solve the problem by increasing the number of the locking member in each handcuff main body, the problem has yet to be effectively eliminated. Research on the conventional handcuffs and related development efforts have also failed to produce a proper solution. In consideration of the above, the inventor of the present invention came up with the idea of providing a spacer between two locking members to block one locking member from the other. Thus, a handcuffed person (e.g., a suspect) will be unable to push the locking members at the same time, let alone open the handcuff main bodies of the handcuffs. Consequently, the locking effect of the handcuffs is effectively ensured.

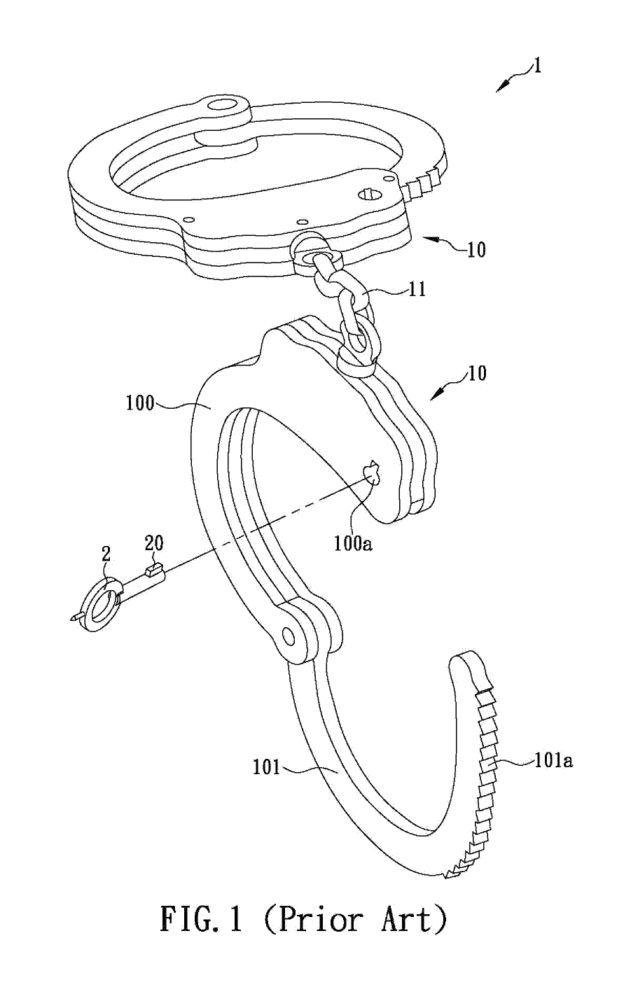

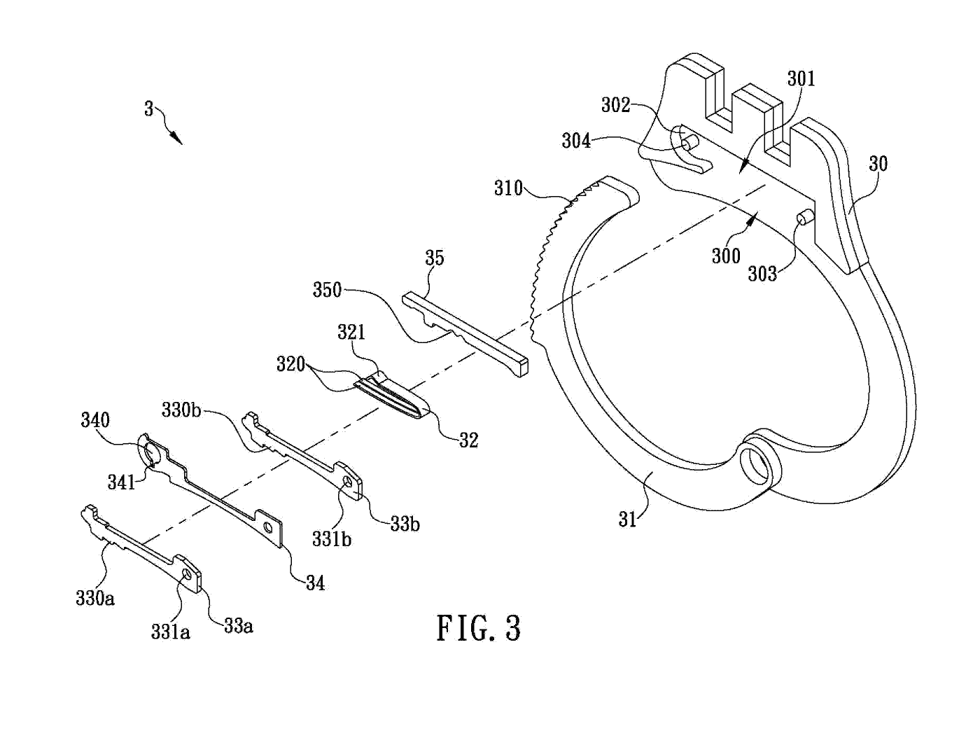

The present invention discloses pick-resistant handcuffs. In a preferred embodiment of the present invention as shown in FIG. 3, the disclosed handcuffs include at least two handcuff main bodies 3, though only one handcuff main body 3 is depicted in the drawing for the sake of simplicity. The number of the handcuff main bodies 3 may vary according to practical needs, and the plural handcuff main bodies 3 are connected by a chain. All changes and modifications readily conceivable by a person skilled in the art should fall within the scope of the present invention. The handcuff main body 3 includes a fixed arc-shaped hook 30, a movable arc-shaped hook 31, an elastic member 32, two locking members 33a and 33b, and a spacer 34. The fixed arc-shaped hook 30 is formed with an opening 300 on the inner side and has an accommodation chamber 301 extending inward from the opening 300. The accommodation chamber 301 is further extended with a key recessed part 302. It should be pointed out that the fixed arc-shaped hook 30 in the present invention is composed of two metal plates, like the conventional fixed arc-shaped hook 100 shown in FIG. 1; however, one of the metal plates is omitted in FIG. 3 to clearly demonstrate the major technical features of the present invention.

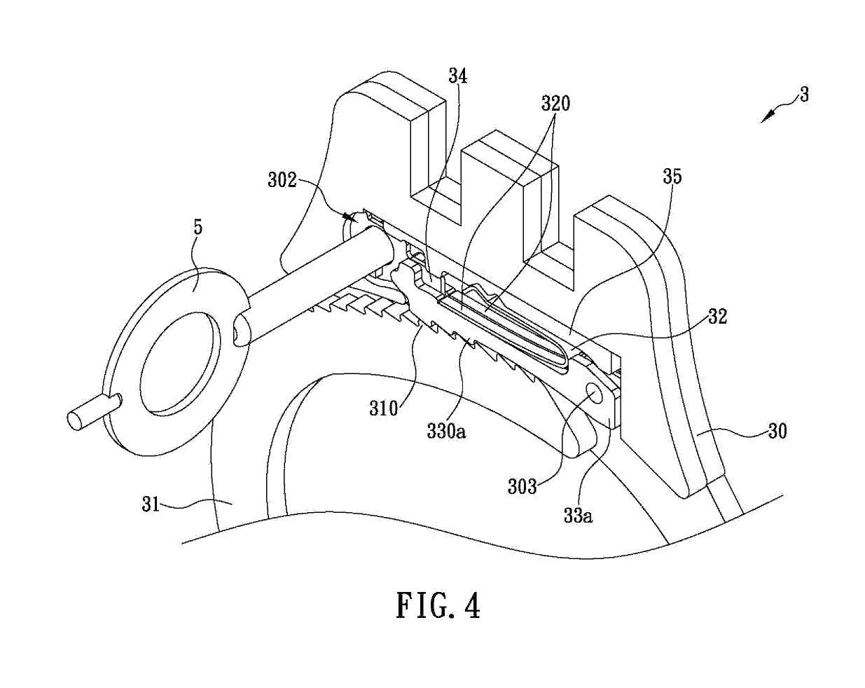

Referring to FIG. 3, the movable arc-shaped hook 31 is pivotally connected to the fixed arc-shaped hook 30 at one end, by a pivot not shown in FIG. 3. Provided adjacent to the other end of, and along the outer periphery (i.e., the left periphery in FIG. 3) of, the movable arc-shaped hook 31 are a plurality of projecting teeth 310. The movable arc-shaped hook 31 can be rotated toward the opening 300 so as for the projecting teeth 310 to correspond in position to the opening 300. The elastic member 32 has a bent configuration and is made of metal; however, the present invention imposes no limitations in the latter regard. Other materials may be used instead to make the elastic member 32, as long as the elastic member 32 is designed and manufactured in accordance with the concept of the present invention. All changes and modifications easily conceivable by a person skilled in the art should fall within the scope of the present invention. A portion of the elastic member 32 that is adjacent to a first end thereof is fixed in the accommodation chamber 301. A portion of the elastic member 32 that is adjacent to a second end thereof is split into two pressing parts 320. In this preferred embodiment, a stop block 35 is received in the accommodation chamber 301 at a position away from the opening 300 (see FIG. 4), and a portion of the stop block 35 that faces the opening 300 is concavely provided with an alignment recessed part 350. Meanwhile, the portion of the elastic member 32 that is adjacent to the first end thereof is bent into an alignment bent part 321. The alignment bent part 321 is located in and abuts against the alignment recessed part 350 to prevent the elastic member 32 from sliding. Thus, structural stability is significantly increased.

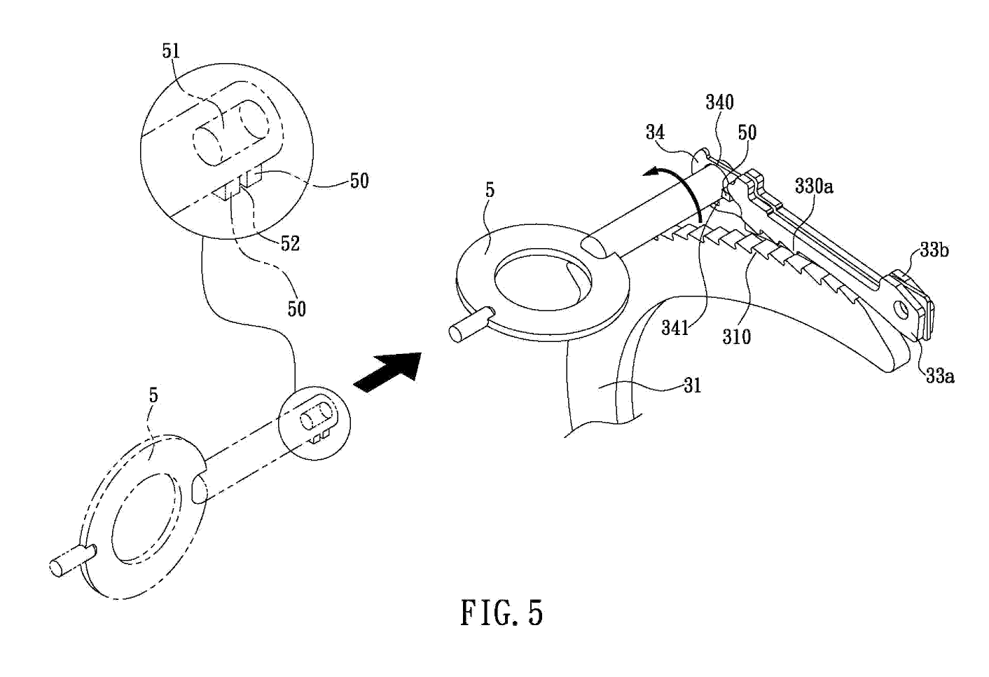

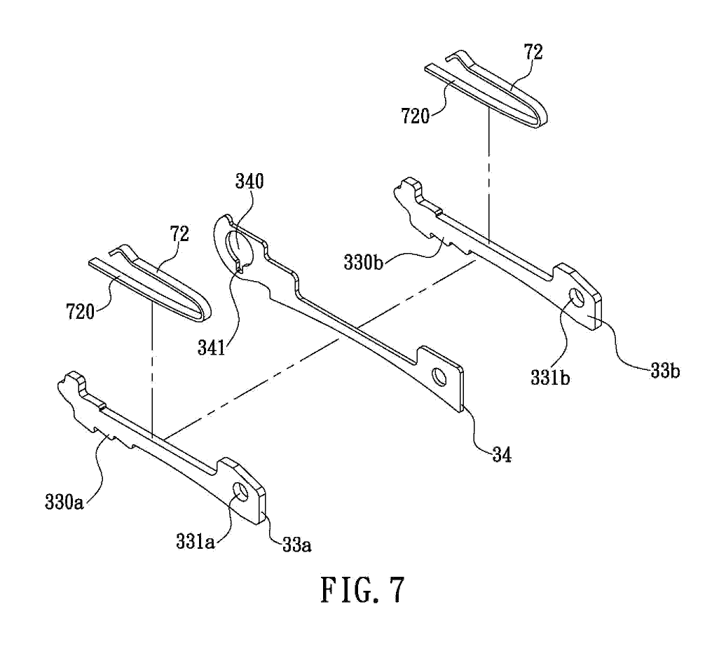

As shown in FIG. 3, the accommodation chamber 301 is protrudingly provided therein with a pivot 303, and the locking members 33a and 33b are penetrated by pivot holes 331a and 331b respectively. The pivot holes 331a and 331b are mounted around the pivot 303 such that the locking members 33a and 33b are pivotally provided in the accommodation chamber 301. The locking members 33a and 33b are respectively provided with a plurality of lock projecting teeth 330a and 330b on the side that is adjacent to the opening 300. Referring to FIG. 4 in conjunction with FIG. 3, the pressing parts 320 of the elastic member 32 press the locking members 33a and 33b respectively and elastically so as for the lock projecting teeth 330a and 330b to engage with the projecting teeth 310 of the movable arc-shaped hook 31. It should be noted that the design of the elastic member 32 is not limited to that described above. In another preferred embodiment as shown in FIG. 7, two elastic members 72 are used in place of the elastic member 32, wherein each elastic member 72 also has a bent configuration. A portion of each elastic member 72 that is adjacent to a first end thereof is fixed in the accommodation chamber 301, and a portion of each elastic member 72 that is adjacent to a second end thereof is formed as a pressing part 720. The pressing parts 720 of the elastic members 72 press the locking members 33a and 33b respectively and elastically to achieve the intended effect of the present invention just as well as in the previous preferred embodiment. Referring back to FIG. 3, the spacer 34 is fixed in the accommodation chamber 301 and situated between the two locking members 33a and 33b. The spacer 34 is formed with a through hole 340. The through hole 340 is adjacent to one end of the spacer 34 and is located in the key recessed part 302. Additionally, the through hole 340 is extended with a tooth hole 341 through which key teeth 50 at the front end of a key 5 (see FIG. 5) can pass. In FIG. 5, the key 5 is provided with two key teeth 50, and a key tooth groove 52 is formed between the two key teeth 50. Referring again to FIG .3, the tooth hole 341 corresponds in configuration to the key tooth groove 52 of the key 5. In other words, the configurations of the through hole 340 and of the tooth hole 341 as a whole match the configuration of the key 5. Further, the key recessed part 302 is protrudingly provided therein with a guide post 304. The guide post 304 corresponds in configuration to a guide groove 51 concavely provided at the front end of the key 5 (see FIG. 5) so that a user can insert the key 5 into the key recessed part 302 correctly.

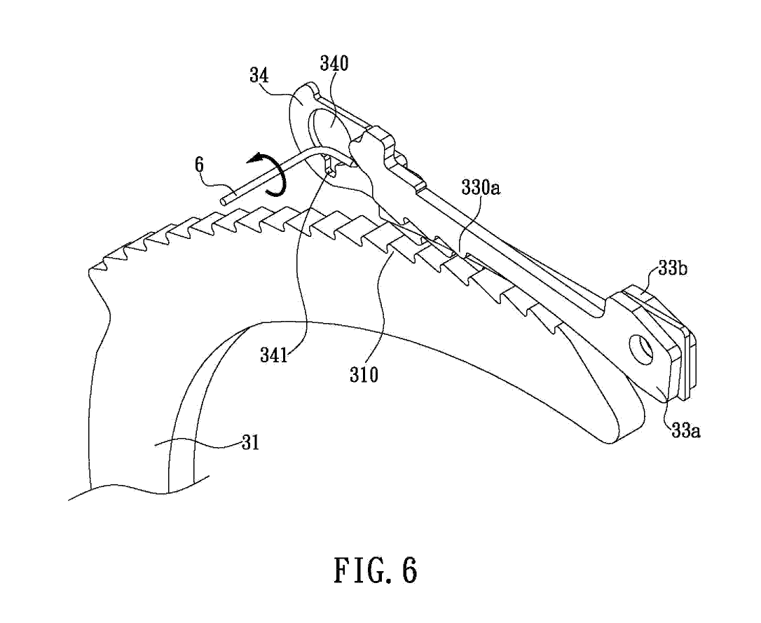

Reference is now made to FIG. 5, in which only the movable arc-shaped hook 31, the locking members 33a and 33b, the spacer 34, and the key 5 are shown while the other components such as the fixed arc-shaped hook 30, the elastic member 32, and the stop block 35 are omitted to better illustrate the operating principle of the present invention. As shown in FIG. 5, when the key 5 is inserted into the key recessed part 302 through the through hole 340 such that one of the key teeth 50 at the front end of the key 5 passes through the tooth hole 341, the two key teeth 50 of the key 5 correspond in position to the locking members 33a and 33b respectively. The key 5 in this state can be turned, causing the two key teeth 50 to push the locking members 33a and 33b simultaneously. As a result, the locking members 33a and 33b are disengaged from the projecting teeth 310 of the movable arc-shaped hook 31, allowing the handcuff main body 3 to be opened. However, referring to FIG. 6, when a handcuffed person (e.g., a suspect) attempting to open the handcuff main body 3 inserts a pointed object 6 (e.g., a metal hairpin, nail, etc.) into the key recessed part 302 (see FIG. 3) and tries to push the locking members 33a and 33b with the pointed object 6, the pointed object 6 can only push one of the locking members, i.e., the locking member 33a, for the locking members 33a and 33b are blocked from each other by the spacer 34, which is fixed in the accommodation chamber 301. Therefore, even if the lock projecting teeth 330a of the locking member 33a are separated from the projecting teeth 310 of the movable arc-shaped hook 31, the other locking member 33b remains engaged with the projecting teeth 310 of the movable arc-shaped hook 31 due to the resilient force of the elastic member 32 (see FIG. 3). As the movable arc-shaped hook 31 is prevented from being disengaged from the locking member 33b, the locking effect of the handcuffs is effectively ensured. Not only that, even if the pointed object 6 is inserted in between the projecting teeth 310 and the lock projecting teeth 330a or 330b (i.e., below the lock projecting teeth 330a or 330b), the pointed object 6 will still be blocked by the spacer 34; therefore, the pointed object 6 can only push one of the locking members and will not contact with the other. As such, the attempt to disengage the movable arc-shaped hook 31 completely from the locking members will end up in vain, and the movable arc-shaped hook 31 still cannot be opened. Moreover, since the pick-resistant handcuffs disclosed herein look just like other handcuffs, a person restrained by the disclosed handcuffs can never know that the handcuffs are pick-resistant. Hence, should the handcuffed person (e.g., a suspect) try to open the handcuffs with a conventional handcuff key (i.e., a key with only one key tooth), the key tooth of the conventional handcuff key will be blocked by the spacer 34 after insertion into the tooth hole 341. Consequently, the key cannot be turned, and the locking members 33a and 33b will not be pushed, thereby effectively preventing the handcuffs from being unlocked by the handcuffed person attempting to escape.

While the invention herein disclosed has been described by means of specific embodiments, numerous modifications and variations could be made thereto by those skilled in the art without departing from the scope of the invention set forth in the claims.

What is claimed is:

1. Pick-resistant handcuffs, comprising at least two handcuff main bodies, each said handcuff main body comprising:
a fixed arc-shaped hook having an inner side formed with an opening, the fixed arc-shaped hook further having an accommodation chamber extending inward from the opening, wherein the accommodation chamber is extended with a key recessed part;
a movable arc-shaped hook having an end pivotally connected to the fixed arc-shaped hook and an opposite end adjacent to which a plurality of projecting teeth are provided along an outer periphery of the movable arc-shaped hook, the movable arc-shaped hook being rotatable toward the opening so that the projecting teeth correspond in position to the opening;
an elastic member of a bent configuration, the elastic member having a first end adjacent to which a portion of the elastic member is fixed in the accommodation chamber, the elastic member further having a second end adjacent to which a portion of the elastic member is split into two pressing parts;
two locking members pivotally provided in the accommodation chamber, each said locking member having a side which is adjacent to the opening and is provided with a plurality of lock projecting teeth, the pressing parts of the elastic member pressing the locking members respectively and elastically so as for the lock projecting teeth of each said locking member to engage with the projecting teeth of the movable arc-shaped hook; and
a spacer fixed in the accommodation chamber and located between the two locking members, the spacer having an end adjacent to which a through hole is formed in the spacer, wherein the through hole is located in the key recessed part and is extended with a tooth hole corresponding in configuration to a key tooth groove of a key.

2. The pick-resistant handcuffs of claim 1, wherein in each said handcuff main body, the accommodation chamber is protrudingly provided therein with a pivot, and each said locking member is penetrated by a pivot hole, the pivot holes being mounted around the pivot such that the locking members are pivotally provided in the accommodation chamber.

3. The pick-resistant handcuffs of claim 2, wherein in each said handcuff main body, the key recessed part is protrudingly provided therein with a guide post corresponding in configuration to a guide groove concavely provided at a front end of the key.

4. The pick-resistant handcuffs of claim 3, wherein in each said handcuff main body, a stop block is further provided which is received in the accommodation chamber at a position away from the opening and which is concavely provided with an alignment recessed part at a position facing the opening, and the portion of the elastic member that is adjacent to the first end thereof is bent into an alignment bent part which is located in and abuts against the alignment recessed part.

5. Pick-resistant handcuffs, comprising at least two handcuff main bodies, each said handcuff main body comprising:
a fixed arc-shaped hook having an inner side formed with an opening, the fixed arc-shaped hook further having an accommodation chamber extending inward from the opening, wherein the accommodation chamber is extended with a key recessed part;
a movable arc-shaped hook having an end pivotally connected to the fixed arc-shaped hook and an opposite end adjacent to which a plurality of projecting teeth are provided along an outer periphery of the movable arc-shaped hook, the movable arc-shaped hook being rotatable toward the opening so that the projecting teeth correspond in position to the opening;
two elastic members of a bent configuration, each said elastic member having a first end adjacent to which a portion of the each said elastic member is fixed in the accommodation chamber, each said elastic member further having a second end adjacent to which a portion of the each said elastic member is formed as a pressing part;
two locking members pivotally provided in the accommodation chamber, each said locking member having a side which is adjacent to the opening and is provided with a plurality of lock projecting teeth, the pressing parts of the elastic members pressing the locking members respectively and elastically so as for the lock projecting teeth of each said locking member to engage with the projecting teeth of the movable arc-shaped hook; and
a spacer fixed in the accommodation chamber and located between the two locking members, the spacer having an end adjacent to which a through hole is formed in the spacer, wherein the through hole is located in the key recessed part and is extended with a tooth hole corresponding in configuration to a key tooth groove of a key.

6. The pick-resistant handcuffs of claim 5, wherein in each said handcuff main body, the accommodation chamber is protrudingly provided therein with a pivot, and each said locking member is penetrated by a pivot hole, the pivot holes being mounted around the pivot such that the locking members are pivotally provided in the accommodation chamber.

7. The pick-resistant handcuffs of claim 6, wherein in each said handcuff main body, the key recessed part is protrudingly provided therein with a guide post corresponding in configuration to a guide groove concavely provided at a front end of the key.

8. The pick-resistant handcuffs of claim 7, wherein in each said handcuff main body, a stop block is further provided which is received in the accommodation chamber at a position away from the opening and which is concavely provided with an alignment recessed part at a position facing the opening, and the portion of each said elastic member that is adjacent to the first end thereof is bent into an alignment bent part which is located in and abuts against the alignment recessed part.
